(19) United States
(12) Patent Application Publication
(10) Pub. No.: US 2009/0260226 A1
(43) Pub. Date: Oct. 22, 2009

(54) DEVICE FOR ASSEMBLING AN ELECTRONIC COMPONENT

(75) Inventors: Xavier Tinguely, Dombresson (CH); Kim Dat Tran, Bienne (CH); Alain Schorderet, Chavannes-pres-Renens (CH)

Correspondence Address: GRIFFIN & SZIPL, PC, SUITE PH-1, 2300 NINTH STREET, SOUTH, ARLINGTON, VA, 22204, US

(73) Assignee: MICROCOMPONENTS S.A., Grenchen (CH)

(21) Appl. No.: 12/428,037

(22) Filed: Apr. 22, 2009

(30) Foreign Application Priority Data
Apr. 22, 2008 (EP) 08154967.7

(51) Int. Cl. B23P 19/00

(52) U.S. Cl. 29/739

(57) ABSTRACT

The invention concerns a device (1) for assembling an electronic component (2) including an outer case (3). This case is for connection to an external electric circuit via contact means (4) and is arranged for containing a support (5), to which the electronic component (2) is secured. The support is arranged for connection to the contact means of the outer case via at least one contact pad (8) placed on the support. The contact pad enables the electronic component secured to the support to be electrically connected to the contact means of the outer case via connecting means (6). In particular, the connecting means and the electronic component support are arranged such that the support is suspended by the connecting means so that the support remains mobile.

The present invention concerns a device for assembling an electronic component, said assembly device including an outer case connected to an external electric circuit via contact means and containing a support to which the electronic component is fixed. The support is to be connected to the contact means of the outer case, via at least one contact pad placed on said support via connecting means. This allows the electronic component fixed to said support to be electrically connected to the contact means of the outer case.

### BACKGROUND OF THE INVENTION

Electronic component assembly devices in the form of cases that enclose a support, on which one or more electronic components are fixed, are already known from the prior art. Originally, these components were rigidly secured directly to the back cover of the case. However, these constructions, although simple to make, have drawbacks as soon as the components fixed to said case do not accommodate this rigidity.

In fact, the main drawback of rigidly fixing the component to the case is that all of the vibrations and shocks applied to the case hit the component, which is fixed thereto. While this is harmless for components with transistors, such as logic gates, memories or passive components it becomes extremely detrimental for sensitive components. Indeed, in the case of components such as resonators or gyroscopes, which vibrate or generate vibrations so as to supply data or drive a circuit, the application of stray external vibrations to the integrated circuit case causes a drift from the operating parameters of the components.

This is why systems that attenuate vibrations have been devised.

There therefore exist in the prior art inventions whose object is to overcome problems linked to disturbance induced by external mechanical shocks. We may cite, for example, FR Patent No. 2 692 719, which uses a sheet of elastic material placed at the bottom of the external case between said bottom of the case and the electronic component for damping the external vibrations that could be transmitted to the component. The electronic component is electrically powered by connecting wires.

One of the problems of this type of system lies in the fact that two distinct elements have to be used to make the electrical connection and the damper. On the one hand, this means the case has to be altered so that the damping means can be placed inside it, and on the other hand, an increase in the complexity of the system, which also causes an increase in production costs.

### SUMMARY OF THE INVENTION

The invention concerns a device for assembling an electronic component which overcomes the aforementioned drawbacks of the prior art by reducing the complexity and space requirement of the damping system while improving the efficiency thereof and limiting costs.

The invention therefore concerns an assembly device as cited above, which is characterized in that the connecting means and the electronic component support are arranged such that said support is suspended by said connecting means so that said support remains mobile.

One advantage of the device for assembling an electronic component according to the invention is that it provides a simple damping system. Indeed, a single element is used to make both the electric connection and the damper. This element, which is the connecting means, electrically connects the electronic component, which is secured to the support, to the contact pads of the other case and thus to any electric circuit, and elastically damps said support to which said component is secured.

This dual function of the connecting means is made possible by the natural features of the connecting means used.

Moreover, the simplicity of the damper system means that the structure of the outer case does not have to be altered, thus avoiding additional design costs.

Advantageous embodiments form the subject of the dependent claims 2 to 21.

### BRIEF DESCRIPTION OF THE DRAWINGS

The objects, advantages and features of the device for assembling an electronic component will appear more clearly in the following detailed description of at least one embodiment of the invention, given solely by way of non-limiting example and illustrated by the annexed drawings, in which:

FIGS. 1a and 1b show schematically the electronic component assembly device according to the present invention,

FIGS. 2a and 2b show schematically a transverse cross-section of the electronic component assembly device according to the present invention,

FIGS. 3 and 4 respectively show schematically top and bottom views of the electronic component assembly device according to the present invention using a first type of connecting means,

FIG. 5 shows schematically a top view of the electronic component assembly device according to the present invention using a second type of connecting means,

FIG. 6 shows schematically a bottom view of the electronic component assembly device according to the present invention using a second type of connecting means, and

FIG. 7 shows schematically the electronic component assembly device according to the present invention using a complementary damper system.

### DETAILED DESCRIPTION

In the following description, all of the parts of the electronic component assembly device that are well known to those skilled in the art will be explained only in a simplified manner.

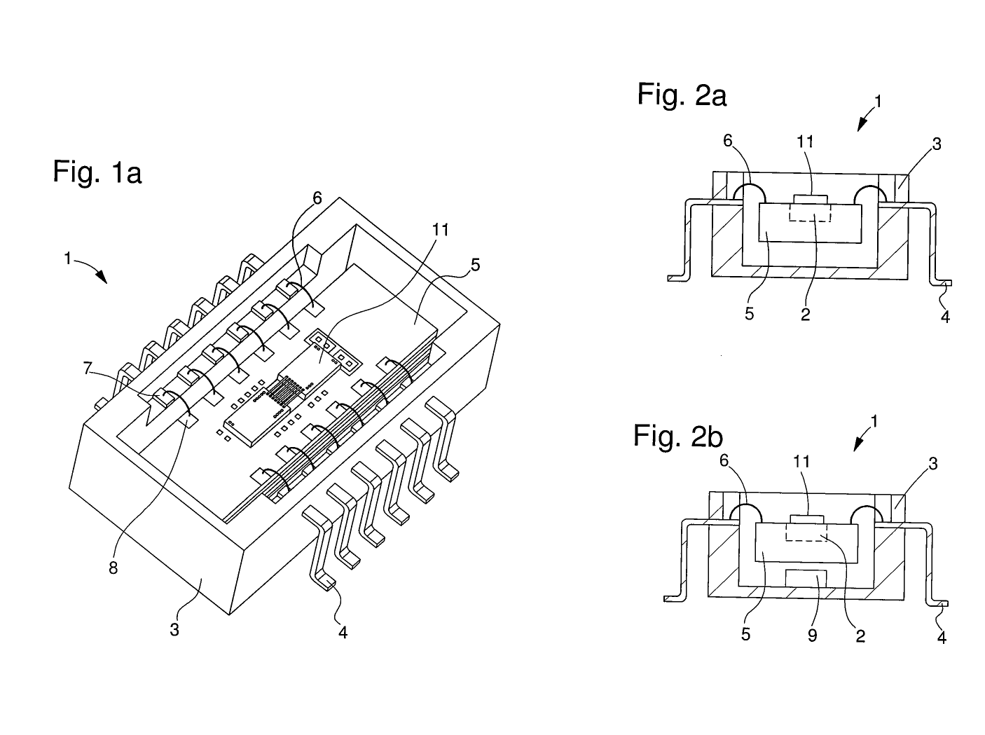

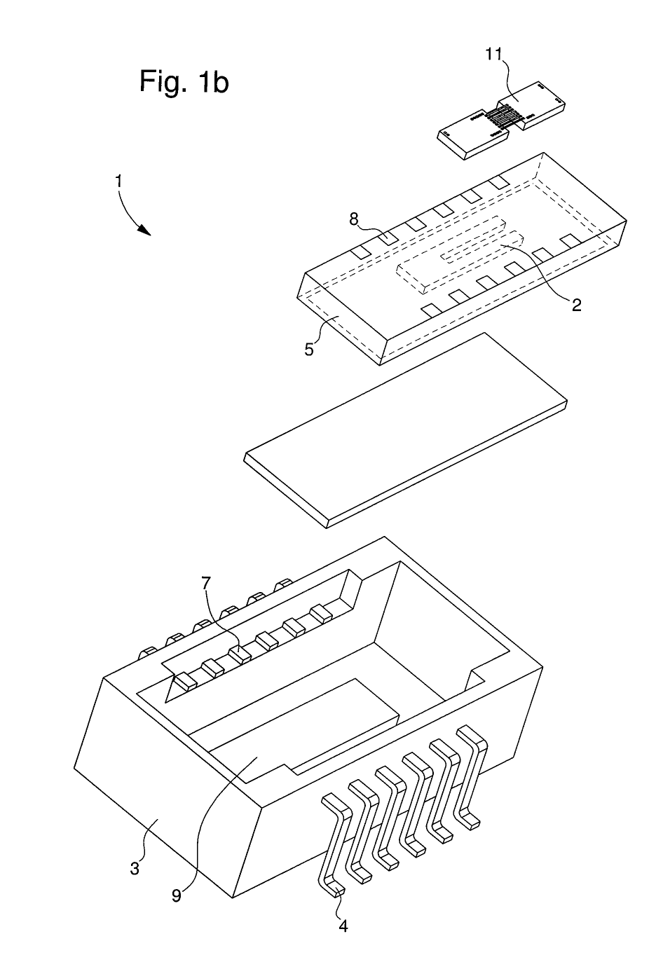

FIGS. 1a and 1b show schematically the electronic component assembly device according to the present invention in its simplest embodiment. This assembly device 1, in which an electronic component 2 is mounted, includes an outer case 3 connected to an outer electric circuit via contact means 4. A support 5, to which electronic component 2 is secured, is placed inside outer case 3. This support 5 includes contact pads 8 electrically connected to electronic component 2. The latter is electrically connected to contact means 4 of outer case 3 via connecting means 6, which connect contact means 4 to contact pads 8.

Intermediate contact pads 7 could also be provided in case 3. Thus, connecting means 6 would connect the connecting pads 8 of support 5 to contact pads 7 of case 3, the latter then being electrically connected to contact means 4 of said case 3.

Outer case 3 has several functions, the first of which is to form the electric connection between electronic component 2 which it encloses and the outer electric circuit (not shown) to which case 3 is secured. Outer case 3 can also be used as a heat sink to evacuate the Joule effect energy produced by said component 2, if this proves necessary. Finally, case 3 also has a protective function since it is used to protect electronic component 2 from any hostile attack from the external environment, such as shocks, heat, damp, etc. This case is made of rigid materials, such as ceramics, liquid crystal polymer (LCP), polyester carbonate (PEC) or any other material used in the field of electronic components. It is connected to an external electrical circuit (not shown) via contact means 4. In this case, these contact means 4 are lugs symmetrically arranged on two of the sides of case 3. However, these contact means may take any possible form and arrangement that fulfil the function of electrically connecting case 3 to an external electric circuit. One could cite, for example, a ball grid array (BGA) where the balls underneath case 3 form the electrical connection with the external electric circuit.

There is a support 5 inside case 3 to which the desired electronic component 2 is secured. The main function of support 5 is to act as a base which will be suspended, for component 2, which will be fixed thereto. Component 2 will therefore also be suspended.

Support 5 and contact means 4 of outer case 3 are electrically connected by connecting means. This enables the electronic component fixed to support 5 to be electrically connected to contact means 4 of outer case 3 and thus, thereby, to an external electric circuit.

As mentioned above, sensitive components, like resonators or gyroscopes require some insulation against vibrations and external shocks. The present invention thus proposes to overcome this problem by using connecting means 6 as suspension means. This use of connecting means 6 as suspension means saves space and simplifies the system since a single element is used to fulfil two functions: electrical connection and suspension. This reduces costs and development time and makes industrial production simpler. This suspension function, which is achieved with connecting means 6, is the result of the natural or intrinsic features of the materials used.

In fact, the connecting means are flexible, which enables support 5, to which electronic component 2 is secured, to be suspended. In other words, support 5 is mounted freely in outer case 3, suspended without any support. It is only connecting means 6 that then hold said support 5 suspended.

If any shocks are applied to outer case 3, they reverberate inside said case 3. The features, particularly the flexibility, of connecting means 6 will allow the connecting means to deform in a more or less accentuated way and thus to damp a large part of these external vibrations so as to protect electronic component 2, secured to support 5, from these stray vibrations.

According to a first variant of the invention, as can be seen in FIGS. 1a and 1b, connecting means 6, which connect contact means 4 to contact pads 8, are bonds 6 that a use wire bonding technique. The flexion feature of these bonds 6 depends on the length, diameter and material of which the bonds are made. Bonds 6 are brazed so as to form an arch, i.e. one of the ends of the bond is brazed on a connecting pad 8, while the other end is brazed on one of contact means 4 of outer case 3 or to an intermediate connecting pad 7 of case 3 if the latter has such a pad.

This variant has the advantage of being simple since all of the elements making up the assembly device are known, the inventive contribution being the use of said bonds 6 to suspend support 5 to which electronic component 2 is secured.

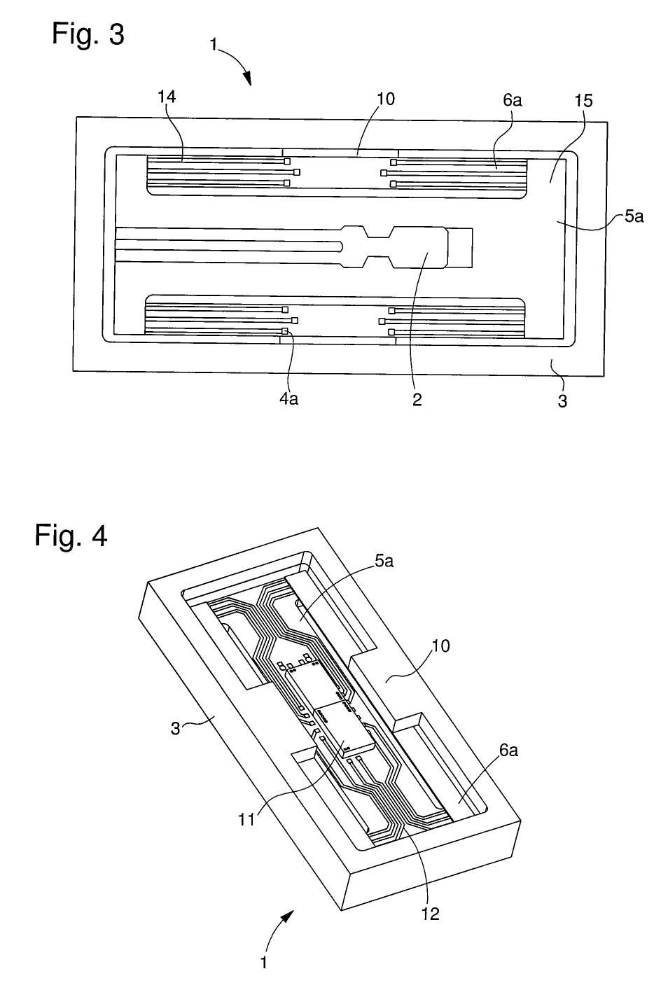

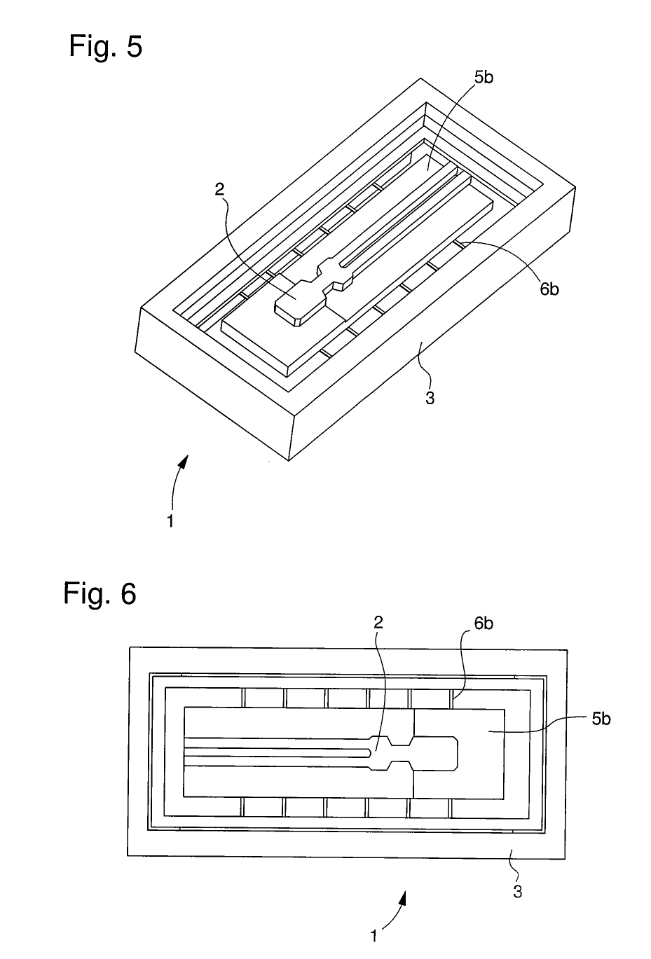

According to a second variant of the assembly device according to the present invention, the connecting means can be made from a flexible printed circuit board 6a. This variant is shown in FIGS. 3 and 4. The flexible printed circuit board 6a is a conventional printed circuit board, i.e. made by means of insulated copper paths on an insulating substrate. The difference between a flexible printed circuit board and a conventional, i.e. rigid one lies in the fact that, for a rigid printed circuit board, the insulating substrate is made of bakelite or rigid epoxy resin, whereas for a flexible printed circuit board, the substrate is made of a flexible material that allows the printed circuit board to deform.

Thus, the connecting means take the form of a strip made of insulating flexible material on which conductive paths 14 are insulated. These paths 14 are arranged such that each of them connects one contact pad 8 of support 5 to one of the contact means of outer case 3, so as to electrically connect said contact means 4 of outer case 3 to electronic component 2.

There again, connecting means 6a offers great flexibility of use since the flexibility of the flexible printed circuit board can be altered by varying the thickness of the substrate, the material forming the substrate, and the length, width and shape of the substrate.

According to a third variant of the present invention shown in FIGS. 5 and 6, a third type of connecting means is envisaged. In this case, the tape automated bonding principle is used. This principle consists in a network of metal strips 6b arranged in a star shape and used as a support for the connecting pads of the electronic circuit. Thus, each strip has one end secured to a contact pad of the electronic component and the other end fixed to a contact pad of the printed circuit board to which the component is secured.

In this case, metal strips 6b are responsible for connecting the contact pads of support 5a to the contact means of outer case 3. Thus, support 5a can be fixed to said strips from the bottom or top. Preferably, the first solution will be used, consisting in placing support 5a on strips.

The advantage of these strips is that provision is already made for this technique so that the component is supported by the connecting means, whence a reduction in costs and development time. Of course, the embodiment examples cited above are only given by way of example and other embodiments could be imagined to fulfil the characteristic function of the present invention.

While it is evident that there are possible variants as regards the connecting means, there are also other advantageous variants of the invention.

Indeed, support 5 is itself one of the elements of the present invention that can take various forms, each having not inconsiderable advantages. The main function of support 5 is to act as a base, to which electronic component 2, which needs to be protected from external vibrations, is secured.

A first variant of support 5 used to secure the electronic component is shown in FIGS. 1a, 1b, 2a and 2b. These Figures show that the support to which the electronic support is fixed takes the form of a case 5. This inner case 5 is a parallelepiped hollowed at the centre. The electronic component to be insulated from vibrations, such as a gyroscope or resonator, for example, can then be mounted inside this inner case 5.

This inner case 5 can be made of any material generally used in the field of electronic components. The inner case 5 is provided with connecting pads 8 for electrically connecting electronic component 2 to contact means 4 of outer case 3. Of course, conductive paths are arranged for connecting said pads to the connection terminals of said electronic component 2.

These connecting pads 8 are however located on the surface of inner case 5 that is best suited to the connecting means 6, 6a, 6b, which will be used.

Indeed, it is possible to use several variants of the connecting means for each type of support. Thus, in the case of a support 5 that has the shape of a case, the use of the connecting means 6 presented above, such as the use of bonds, flexible printed circuit boards or strips, can be envisaged.

One advantage of having two cases one inside the other is that this provides double protection, since the component located inside inner case 5 is sheltered from shocks by two wall levels. Moreover, another advantage is that some types of protection can be localised. In the case of an electronic component that has to be installed in a space under vacuum, the fact of having two cases means that only one of the two cases has to be in a vacuum, namely that case in which the component is placed. Thus, in the event of a shock that damages the outer case 3, the integrity of the vacuum in which the component is located is not compromised.

According to a second variant of the support illustrated in FIGS. 3 and 4, support 5 is a plate 5a of any material. Preferably, this will be a material commonly used in electronic applications. This plate, which acts as support 5, can take any form depending upon the space limitations that must be taken into account.

This plate 5a has contact pads located on its bottom or top surface. Indeed, as for the preceding variant where support 5 took the form of an inner case, this variant is compatible with the three previously proposed variants of connecting means 6, 6a, and 6b. The plate which acts as support 5 to which the electronic component is fixed can thus be suspended by bonding wires, one or more flexible printed circuit boards, or even by a network of metal strips and by any other connecting means that can be envisaged.

In a preferred embodiment shown in FIGS. 3 and 4, this plate is rectangular. At each corner of this plate 5a, projecting portions 15 extend transversely, two projecting portions 15 located on the same side along the longitudinal axis of said plate thus forming a space between them.

This space is then used for sliding in a flexible printed circuit board. The contact pads are therefore located at the level of projecting portions 15. This then enables the flexible printed circuit board, which has conductive paths, to be placed in the spaced formed by the two projecting portions. Thus, electronic component 2, secured to said plate 5a, is electrically connected to said flexible printed circuit board.

A system is then provided on outer case 3 for supporting and electrically securing the unit formed by plate 5a and the two flexible printed circuit boards, one per side of plate 5a.

Two extensions or outgrowths 10 are therefore provided inside outer case 3. These outgrowths 10 are arranged one on top of the other on the longitudinal sides of outer case 3. They are arranged so that they are not underneath plate 5a, which enables the plate to move freely in a vertical direction, without said plate 5a coming into contact with said outgrowths 10. The outgrowths are provided with contact pads and conductive paths 14, each conductive path 14 connecting one contact pad 4a of the outgrowth with one contact means 4 of outer case 3. Each contact pad 4a is arranged to corresponding with one conductive path of a flexible printed circuit board, thus allowing an electrical connection between electronic component 2 and contact means 4 of outer case 3.

Thus, the plate is suspended by the flexible printed circuit boards resting on outgrowths 10. Of course, the number and shape of the outgrowths is in no way set. Likewise, the placing of the outgrowths is not set and they can therefore be installed in the most suitable places.

As stated previously, the peculiar feature of the invention is the use of connecting means as damping elements for insulating the electronic component, which one wishes to place in outer case 3, from external vibrations. In order to improve damping still further, additional damper elements could be added to the present invention.

These then take various forms whose general principle consists in resting the support, to which the electronic component is secured, on an elastic material. A known variant is resting said support 5 on a layer of elastic material such as gel, for example.

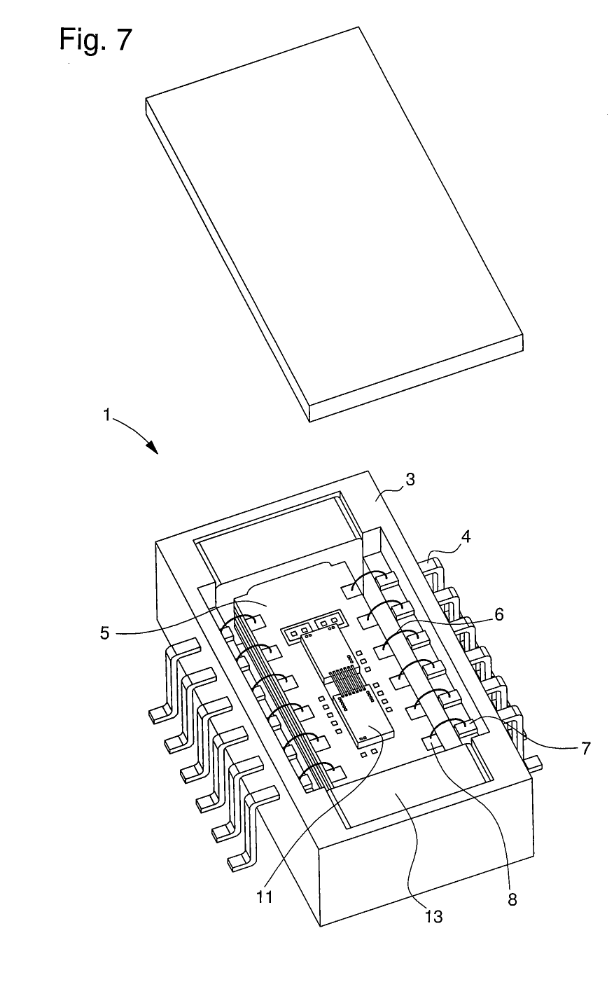

As FIG. 7 shows, the two elements 13 made of elastic material are used to improve damping by providing additional shock absorber capacity. These elements 13 take the form of two elastic supports. These supports are arranged one opposite the other and are secured to support 5 of the electronic component. These elements 13 are preferably secured opposite relative to the transverse axis of said electronic component support 5.

These two elements 13, which are preferably made of silicon, are parallelepiped and arranged to match the inner dimensions of outer case 3. There is a recess on one of the sides of the elements made of elastic material, the length of which matches the width of outer case 3. This recess is arranged to allow electronic component support 5 to fit perfectly, on its transverse edge, into said recess. Thus, by doing this for two opposite sides, support 5 is fixed and supported by said elastic elements 13, as shown in FIG. 7. The whole assembly is then inserted into outer case 3.

Of course, this use of additional damper means works whichever type of support 5 is used.

Again, as regards damping, a stop system could be implemented. This system is used to limit the amplitude of movement of the suspended support 5. Indeed, with the system using connecting means 6 as damper element, the support 5, to which the electronic component is secured, is free to move inside outer case 3. This means, amongst other things, that vibrations due to shocks applied to outer case 3 can be compensated for.

It will be clear then, that the move violent the shock applied, the greater the compensation that has to be made. The connecting means, particularly for the bonds, have limits as regards resistance. This limit may be reached or exceeded if violent shocks are repeatedly applied. Thus, as illustrated in FIGS. 1b and 2b a stop member 9 may be arranged on the bottom of outer case 3 to limit the amplitude of movement of said support 5. The height of this stop member 9 must limit the movement of support 5 to prevent exceeding the maximum amplitude at the risk of breakage.

Preferably, this stop member is a parallelepiped that extends along the longitudinal axis of outer case 3 and the material employed to make stop member 9 is the same as that used for outer case 3. In a preferred version, stop member 9 may be covered with a layer of elastic material so as to absorb shocks when stop member 9 and support 5 come into contact.

It was seen previously that the electronic component is secured to a support 5, which is itself suspended to avoid shocks. Said support 5 can then take various forms such as the form of a plate or an inner case. It is then clear that support 5 is only used for securing the electronic component that has to be insulated and represents a loss of surface. Thus, this support 5 may also have a printed circuit board function for securing other electronic components, in order to reduce the size and complexity of the external electric circuit, to which the outer case 3 is fixed.

An electric routing 12, made from conductive paths, can be installed as seen in FIG. 4. This allows other components 11, such as CMS or SMD components to be secured. One of the advantages is allowing these CMS components to be integrated into support 5 so that they are not mounted on the external electric circuit. For example, these could be components that, whatever the desired application, are always associated with the electronic component that has to be insulated from vibrations. This makes the electric routing of said external electric circuit less complex.

It will be clear that various alterations and/or improvements and/or combinations that are evident to those skilled in the art can be made to the various embodiments of the invention explained above without departing from the scope of the invention defined by the annexed claims.

What is claimed is:

1. A device for assembling an electronic component including an outer case to be connected to an external electric circuit via contact means and arranged for containing a support to which the electronic component is secured, said support is arranged for connection to the contact means of the outer case via at least one contact pad placed on said support, said contact pad enabling the electronic component secured to said support to be electrically connected to the contact means of the outer case via connecting means,
wherein the connecting means and the electronic component support are arranged such that said support is suspended by said connecting means so that said support remains mobile.

2. The device according to claim 1, wherein the connecting means include at least one electrically conductive wire.

3. The device according to claim 1, wherein the connecting means include at least one flexible printed circuit board.

4. The device according to claim 1, wherein the support and the outer case are electrically connected by tape automated bonding.

5. The device according to claim 1, wherein the support is an inner case, which contains the electronic component.

6. The device according to claim 5, wherein the inner case is made of ceramic material.

7. The device according to claim 5, wherein additional damper means are arranged in the outer case to damp said inner case.

8. The device according to claim 7, wherein the additional damper means include at least one layer of elastic materials arranged between the bottom of the outer case and the support surface of the inner case.

9. The device according to claim 8, wherein the elastic material used takes the form of gel.

10. The device according to claim 7, wherein the additional damper means include at least two elements made of elastic materials arranged to fit into the inner case on the edge thereof such that said inner case is resting on the bottom of the outer case via the at least two elements made of elastic material.

11. The device according to claim 10, wherein the elastic material used is silicon.

12. The device according to claim 1, wherein the support is a plate onto the surface of which the electronic component is secured.

13. The device according to claim 3, wherein the support is a plate onto the surface of which the electronic component is secured.

14. The device according to claim 12, wherein the plate has, at each angular end, a projecting portion that extends transversely, two projecting portions on the same side relative to the longitudinal axis of the support thus defining a free space for housing a flexible printed circuit board, said flexible printed circuit board being electrically connected to said plate by at least one connection pad, arranged on each of the projecting portions, the support and flexible printed circuit board assembly being supported by at least two outgrowths arranged on the outer case, said at least two outgrowths thus electrically connecting the plate and the lugs of the outer case via at least one contact pad arranged on each of the outgrowths.

15. The device according to claim 13, wherein the plate has, at each angular end, a projecting portion that extends transversely, two projecting portions on the same side relative to the longitudinal axis of the support thus defining a free space for housing a flexible printed circuit board, said flexible printed circuit board being electrically connected to said plate by at least one connection pad, arranged on each of the projecting portions, the support and flexible printed circuit board assembly being supported by at least two outgrowths arranged on the outer case, said at least two outgrowths thus electrically connecting the plate and the lugs of the outer case via at least one contact pad arranged on each of the outgrowths.

16. The device according to claim 14, wherein the at least two outgrowths are arranged opposite each other relative to the longitudinal axis of the outer case.

17. The device according to claim 14, wherein the at least two outgrowths are located at mid-distance on the total length of the outer case.

18. The device according to claim 1, wherein an electric routing is arranged on one of the surface of the support such that secondary electronic components can be secured thereto.

19. The device according to claim 1, wherein the contact means are lugs.

20. The device according to claim 1, wherein the outer case includes at least one contact pad located on one of the inner sides thereof and connected to the contact means for connecting said contact means of the outer case to the at least one contact pad of the support via the connecting means.

21. The device according to claim 1, wherein the electronic component secured to said support is a resonator or a gyroscope.
